(19) United States
(12) Patent Application Publication
(10) Pub. No.: US 2020/0106079 A1
(43) Pub. Date: Apr. 2, 2020

(54) TERMINAL PROTECTION COVER AND BATTERY MODULE

(71) Applicant: Contemporary Amperex Technology Co., Limited, Ningde City (CN)

(72) Inventors: Kaijie YOU, Ningde City (CN); Derong WANG, Ningde City (CN); Xiupeng YE, Ningde City (CN); Shengshen RUAN, Ningde City (CN)

(73) Assignee: Contemporary Amperex Technology Co., Limited, Ningde City (CN)

(21) Appl. No.: 16/548,375

(22) Filed: Aug. 22, 2019

(30) Foreign Application Priority Data
Sep. 28, 2018 (CN) 201821598774.9

(51) Int. Cl. H01M 2/30; H01R 4/70; H01M 2/10

(52) U.S. Cl. CPC H01M 2/30; H01M 2/1094; H01M 2/1077; H01R 4/70

(57) ABSTRACT

The present disclosure relates to a terminal protection cover and a battery module, the terminal protection cover includes a base portion, including a peripheral region and provided with base openings at the peripheral region; and a side wall, connected to the peripheral region and extending in a first direction, wherein the side wall is provided with two or more groups of side openings spaced apart from each other and extending in the first direction, and at least one base opening is located between adjacent two groups of side openings such that a portion of the side wall can be removed by means of the at least one base opening and the adjacent two groups of side openings. The present disclosure can prevent accidents such as short circuit of the modules or electric shock of an operator during transportation of the battery modules, without affecting the connection between the battery modules.

### CROSS REFERENCE TO RELATED APPLICATION

This application claims priority to Chinese Patent Application No. 201821598774.9, filed on Sep. 28, 2018, which is hereby incorporated by reference in its entirety.

### TECHNICAL FIELD

The present disclosure relates to a technical filed of power battery devices, and particularly relates to a terminal protection cover and a battery module.

### BACKGROUND

In the prior art, module output electrodes of battery modules have various configurations. Since connection between the battery modules must be realized through the module output electrodes, the module output electrodes are provided with open connection ports. However, during transportation of the battery modules, and before the battery modules are connected to each other, the open connection port may cause an accident such as short circuit of the modules and electric shock of an operator.

Therefore, there is a dire need for a new terminal protection cover and battery module.

### SUMMARY

The embodiments of the present disclosure provide a terminal protection cover and a battery module, which can prevent short circuit of the modules and electric shock of an operator during transportation of the battery modules.

One aspect of the embodiments of the present disclosure provides a terminal protection cover for a battery module, comprising a base portion, comprising a peripheral region and provided with base openings at the peripheral region; and a side wall, connected to the peripheral region and extending in a first direction, wherein the side wall is provided with two or more groups of side openings spaced apart from each other and extending in the first direction, and at least one base opening is located between adjacent two groups of side openings such that a portion of the side wall can be removed by means of the at least one base opening and the adjacent two groups of side openings.

According to one aspect of the present disclosure, the base opening is formed as a blind slot recessed into the base portion in a thickness direction of the base portion, or a through slot extending through the entire base portion in the thickness direction of the base portion.

According to one aspect of the present disclosure, between adjacent two groups of side openings, there is disposed one base opening, or there are disposed two or more base openings spaced apart from each other.

According to one aspect of the present disclosure, each group of side openings comprises one or more side wall slots recessed into the side wall in a thickness direction of the side wall, and in the case that each group of the side openings comprises two or more side wall slots, the two or more side wall slots are spaced apart in the first direction.

According to one aspect of the present disclosure, the side wall slot is formed as a blind slot, or a through slot extending through the entire side wall in the thickness direction of the side wall.

According to one aspect of the present disclosure, the side wall is formed into a circular cylinder or an elliptical cylinder.

According to one aspect of the present disclosure, the terminal protection cover comprises two or more base openings, and the two or more base openings are respectively located between adjacent two groups of side openings.

According to one aspect of the present disclosure, the side wall comprises three or more sub-side plates, each of which comprises two side connecting edges opposite to each other and extending in the first direction, wherein the three or more sub-side plates are connected to each other through the side connecting edges to form a prism, and the side openings are disposed adjacent to the side connecting edges.

According to one aspect of the present disclosure, the terminal protection cover comprises three or more groups of side openings, and the three or more groups of side openings are respectively disposed adjacent to the side connecting edges of the three or more sub-side plates; and the terminal protection cover comprises three or more base openings, and the three or more base openings are respectively located between adjacent two groups of side openings.

A further aspect of the present disclosure provides a battery module, comprising: a plurality of unit cells stacked in a second direction; an end plate, disposed on one side of the plurality of unit cells in the second direction and provided with a limit through slot at an end in the first direction; an upper cover, disposed on one side of the plurality of unit cells in the first direction, wherein the upper cover is provided with a groove disposed corresponding to the limit through slot; an output component, comprising a limit terminal and an output terminal continuously connected to each other, wherein the limit terminal is located in the limit through slot and the output terminal is located in the groove; and a terminal protection cover as described above, for covering the output terminal and located in the groove.

According to one aspect of the present disclosure, the side wall of the terminal protection cover is provided with a snap component such that the terminal protection cover can be secured to the output terminal and/or the upper cover by the snap component in a snap fit manner.

According to one aspect of the present disclosure, the groove comprises a first inner wall, a second inner wall, a third inner wall and a bottom wall, wherein the first inner wall and the second inner wall are disposed opposite to each other and are connected by the bottom wall, and the bottom wall is provided with a mating snap member; and the snap component comprises a first snap member disposed toward the third inner wall, and the first snap member is fitted with the mating snap member such that the terminal protection cover can be secured to the upper cover via the first snap member and the mating snap member in the snap fit manner.

According to one aspect of the present disclosure, the snap component comprises two or more second snap members spaced apart in a circumferential surface of the side wall; and the output component is provided with two or more matching snap members on an outer surface, and the two or more matching snap members are respectively disposed corresponding to the two or more second snap members such that the terminal protection cover is secured to the output terminal via the two or more second snap members and the two or more matching snap members in the snap fit manner.

In the embodiment of the present disclosure, the terminal protection cover of the battery module includes the base portion and the side wall connected to the peripheral region of the base portion, and the base portion and the side wall can cover an outer surface of the output terminal of the battery module. Therefore, during transportation of the battery module, accidents such as short circuit of the modules or electric shock of an operator can be effectively prevented due to the protection of the base portion and the side wall. Further, when connecting the battery modules to each other, live terminal inside the terminal protection cover can be exposed by removing portion of the side wall by means of the base openings and the side openings, thereby facilitating connection between the battery modules. Therefore, by the present disclosure, the accidents such as short circuit of the modules or electric shock of an operator during the transportation of the battery modules can be prevented without affecting the connection between the battery modules.

### BRIEF DESCRIPTION OF THE DRAWINGS

Other features, advantages, and technical effects of the present disclosure will become more apparent by reading the following detailed description on non-limiting embodiments with reference to accompanying drawings, wherein the same or similar reference numerals indicate the same or similar features.

FIG. 1 schematically shows a partial exploded view of a configuration of a battery module according to an embodiment of the present disclosure;

FIG. 2 schematically shows a partial assembly view of a configuration of a battery module according to an embodiment of the present disclosure;

FIG. 3 schematically shows a configuration of a terminal protection cover according to an embodiment of the present disclosure;

FIG. 4 schematically shows a configuration of a terminal protection cover according to an embodiment of the present disclosure from another view;

FIG. 5 shows a use state view of a terminal protection cover according to an embodiment of the present disclosure;

FIG. 6 shows a further use state view of a terminal protection cover according to an embodiment of the present disclosure;

FIG. 7 shows a further use state view of a terminal protection cover according to an embodiment of the present disclosure;

### DESCRIPTION OF THE REFERENCE NUMERALS

100, unit cell;
200, end plate; 210, limit through slot;
300, upper cover; 310, groove; 320, mating snap member;
400, output component; 410, limit terminal; 420, output terminal; 421, matching snap member;
500, terminal protection cover;
510, base portion; 511, peripheral region; 512, base opening;
520, side wall; 521, side opening; 521a, side wall slot; 522, sub-side plate;
530, snap component; 531, first snap member; 532, second snap member;
600, connecting member;
X, second direction;
Z, first direction.

### DETAILED DESCRIPTION

Features and exemplary embodiments of various aspects of the present disclosure will be described in detail below. In the following detailed description, numerous specific details are set forth to provide a full understanding of the present disclosure. However, it shall be apparent to the person skilled in the art that the present disclosure may be implemented without some of the details. The following description of the embodiments is merely made to provide a better understanding of the present disclosure by showing examples of the present disclosure. In the figures and the following description, at least some of well-known structures and techniques are not shown to avoid unnecessarily obscuring the present disclosure. Further, for clarity, size of a portion of the structure may be exaggerated. Furthermore, features, structures, or characteristics described hereinafter may be combined into one or more embodiments in any suitable manner.

Orientations in the following description refer to directions as shown in the figures, and are not intended to define specific structure of the embodiments of the present disclosure. In the description of the present disclosure, it shall be noted that, unless otherwise clearly stated and defined, the terms such as “installation”, “connected” shall be understood broadly, may be, for example, a fixed connection, a disassemble connection, or an integral connection, and may be direct connection or indirect connection through an intermediate medium. The specific meaning of the above terms in the present disclosure can be understood by the person skilled in the art according to actual circumstance.

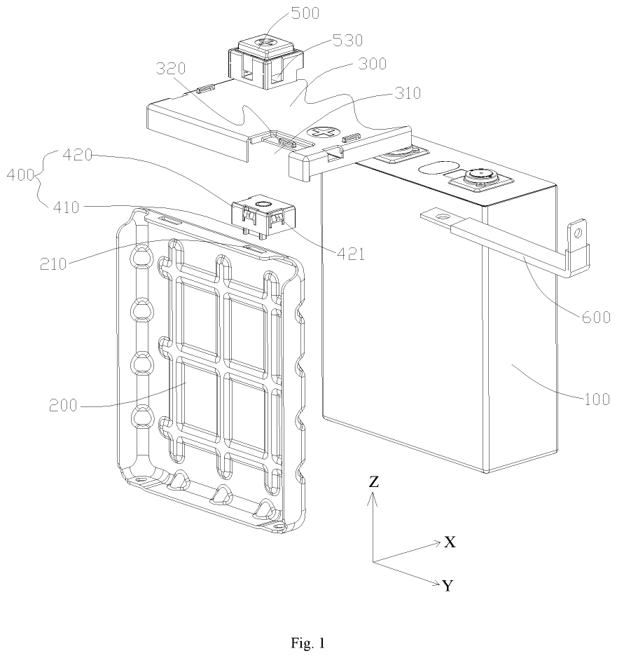

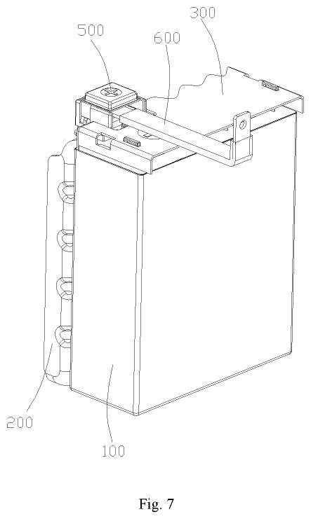

For a better understanding of the present disclosure, a terminal protection cover and a battery module according to an embodiment of the present disclosure will be described in detail below with reference to FIG. 1 to FIG. 7.

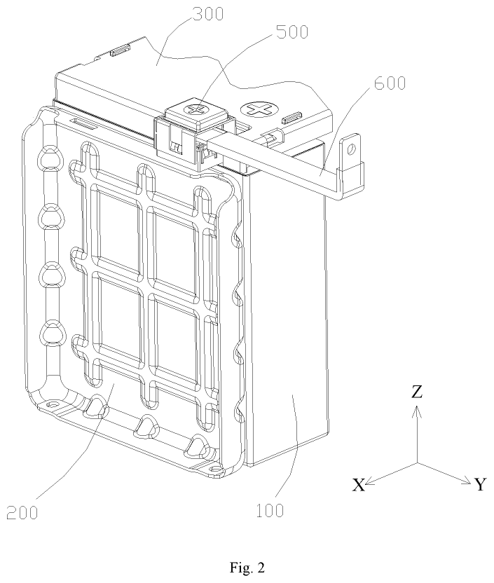

FIG. 1 is a schematic exploded view showing a configuration of a battery module according to an embodiment of the present disclosure, and FIG. 2 is a schematic view showing a configuration of an assembled battery module according to an embodiment of the present disclosure. The battery module includes a plurality of unit cells 100 (FIG. 1 shows only one unit cell 100) arranged side by side in a second direction (X direction as shown in FIG. 1); an end plate 200 disposed on one side of the plurality of unit cells 100 in the X direction and provided with a limit through slot 210 on an upper portion of a body of the end plate 200; an upper cover 300 disposed above the unit cells 100 in a Z direction and provided with a groove 310 corresponding to the limit through slot 210; an output component 400 including a limit terminal 410 and an output terminal 420 continuously connected to each other, with the limit terminal 410 located in the limit through slot 210 and the output terminal 420 located in the groove 310; and a terminal protection cover 500 for covering the output terminal 420 and located in the groove 310. The output terminal 420 is provided with a conductive portion, which can be connected to an external connecting member 600, to realize an electrical connection between different battery modules.

The terminal protection cover 500 may be fixed in various manners. For example, the terminal protection cover 500 is provided with a snap component 530 and the terminal protection cover 500 is fixedly connected to the output terminal 420 and/or the upper cover 300 by the snap component 530 in a snap member.

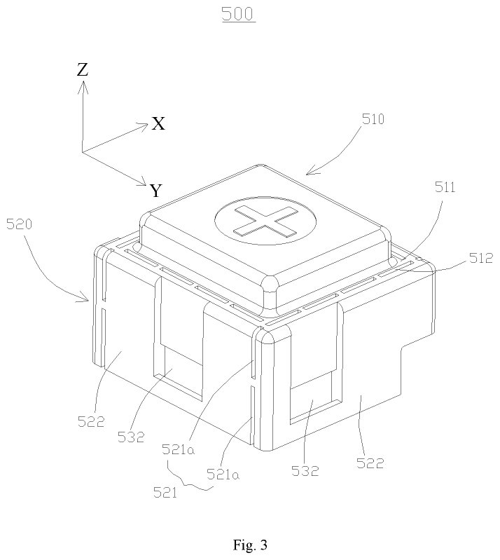

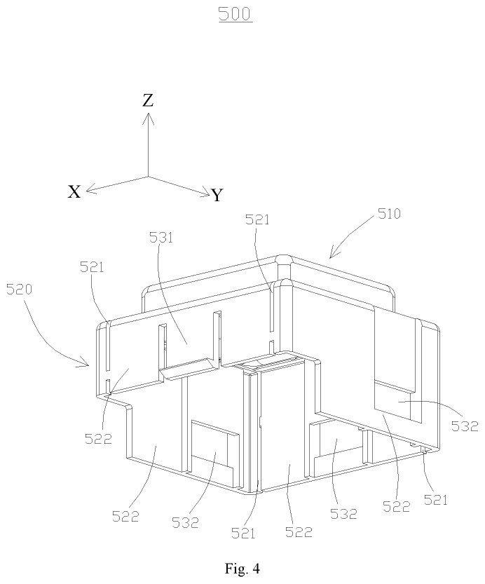

The terminal protection cover 500 may be formed in various manners. As shown in FIG. 3 and FIG. 4, FIG. 3 and FIG. 4 are schematic diagrams showing a configuration of a terminal protection cover 500 of the battery module according to an embodiment of the present disclosure. The terminal protection cover 500 includes: a base portion 510, including a peripheral region 511 and provided with base openings 512 at the peripheral region 511; and a side wall 520, connected to the peripheral region 511 and extending in the Z direction, wherein the side wall 520 is provided with two or more groups of side openings 521 spaced apart from each other and extending in the Z direction, and at least one base opening 512 is located between adjacent two groups of side openings 521 such that a portion of the side wall 520 can be removed by means of the at least one base opening 512 and the adjacent two groups of side openings 521.

A shape of the base portion 510 is not particularly limited herein, as long as the base portion 510 includes a peripheral region 511 and the peripheral region 511 is provided with base openings 512. For example, the base portion 510 may be formed in a shape of plate or in other shapes. Preferably, the base portion 510 is fitted with a top portion of the output terminal 420 in shape. As a result, when the terminal protection cover 500 is mounted and cover the output terminal 420, a free space inside the terminal protection cover 500 can be reduced, thereby increasing an energy density of the battery module.

A manner in which the side wall 520 and the peripheral region 511 are connected is not particularly limited herein, and the side wall 520 may be connected to an edge of the peripheral region 511 or an internal portion of the peripheral region 511. In some optional embodiments, the side wall 520 is connected to the edge of the peripheral region 511. This is conducive to reducing a space occupied by the terminal protection cover 500 while keeping an inside space of the terminal protection cover 500 unchanged, thereby increasing the energy density of the battery module.

In the embodiment of the present disclosure, the terminal protection cover 500 of the battery module includes the base portion 510 and the side wall 520 connected to the peripheral region 511 of the base portion 510, and the base portion 510 and the side wall 520 can cover an outer surface of the output terminal 420 of the battery module. Therefore, during transportation of the battery module, accidents such as short circuit of the modules or electric shock of an operator can be effectively prevented due to the protection of the base portion 510 and the side wall 520. Further, when connecting the battery modules to each other, live terminal inside the terminal protection cover 500 can be exposed by removing a portion of the side wall 520 by means of the base openings 512 and the side openings 521, thereby facilitating connection between the battery modules. Therefore, by the present disclosure, the accidents such as short circuit of the modules or electric shock of an operator during the transportation of the battery modules can be prevented without affecting the connection between the battery modules.

The snap component 530 can be formed in various manners. In some optional embodiments, the groove 310 includes a first inner wall, a second inner wall, a third inner wall and a bottom wall, wherein the first inner wall and the second inner wall are disposed opposite to each other and are connected by the bottom wall, and the bottom wall is provided with a mating snap member 320. The snap component 530 includes a first snap member 531 disposed towards the third inner wall of the groove 310. The first snap member 531 is fitted with the mating snap member 320, such that the end protection cover 500 can be secured to the upper cover 300 via the first snap member 531 and the mating snap member 320 in a snap fit manner.

The specific configurations of the first snap member 531 and the mating snap member 320 are not particularly limited herein, as long as the first snap member 531 and the mating snap member 320 can be secured to each other in the snap fit manner. For example, the first snap member 531 is formed as a hole, and the mating snap member 320 is formed as a hook matching with the hole; or, the first snap member 531 is formed as a hook, and the mating snap member 320 is formed as a hole matching with the hook.

The base opening 512 can be formed in various manners, as along as the base portion 510 can be broken by means of the base opening 512 so as to remove a portion of the side wall 520. For example, the base opening 512 can be a blind slot recessed into the base portion 510 in a thickness direction of the base portion 510, or the base opening 512 can be a through slot extending through the entire base portion 510 in the thickness direction of the base portion 510.

The side openings 521 may be formed in various manners. In some optional embodiments, each group of side openings 521 includes one or more side wall slots 521a recessed into the side wall 520 in a thickness direction of the side wall 520. In the case that each group of side openings 521 includes two or more side wall slots 521a, the two or more side wall slots 521a are spaced apart in the Z direction. Preferably, each group of side openings 521 includes two or more side wall slots 521a spaced apart, to facilitate broken and removal of the side wall 520. The side wall slot 521a may be a blind slot recessed into the side wall 520 in the thickness direction of the side wall 520 or a through slot extending through the entire side wall 520 in the thickness direction of the side wall 520.

The number of the base openings 512 between adjacent two groups of side openings 521 is not particularly limited herein. There may be disposed only one base opening 512, or there may be disposed two or more base openings 512 spaced apart from each other, between adjacent two groups of side openings 521. Preferably, two or more base openings 512 spaced apart from each other are disposed between adjacent two groups of side openings 521. As such, the base opening 512 may have a shorter extending length, and a portion of the base portion 510 connecting the two or more base openings 512 can improve a strength of the base portion 510, thereby preventing the terminal protection cover 500 from being deformed due to crushing during transportation.

It shall be understood that the shape of the base portion 510 is not particularly limited herein, as along as the side wall 520 is connected to the peripheral region 511 of the base portion 510 such that the end protection cover 500 can be mounted and cover the output terminal 410. For example, a projection of the base portion 510 on a first plane may be circular, elliptical, polygonal, or in other irregular shapes. Wherein, the first plane is a plane perpendicular to the Z direction, that is, an X-Y plane.

In some optional embodiments, the projection of the base portion 510 on the first plane is circular, and the side wall 520 is formed into a circular cylinder; or, the projection of the base portion 510 on the first plane is elliptical, and the side wall 520 is formed into an elliptical cylinder.

In the case that the side wall 520 is formed into the circular cylinder or the elliptical cylinder, two or more base openings 512 are provided and respectively located between adjacent two groups of side openings 521. In these optional embodiments, two groups of side openings 521 divide the side wall 520 into two portions and the two or more base openings 512 are respectively located between the adjacent two groups of side openings 521, so that either portion of the side wall 520 can be broken off and removed by means of one of the base openings 512 and the adjacent two groups of side openings 521. Thus, when electrically connecting the battery modules to each other, the portions of the side wall 520 can be selectively removed according to actual requirements and connection orientations.

The arrangement of the two or more groups of side openings 521 is not particularly limited herein. In some optional embodiments, the two or more groups of side openings 521 are evenly distributed in a circumferential direction of the side wall 520, such that the removed portions of the side wall 520 are equal in size.

The number of the groups of side openings 521 is not particularly limited herein. In some optional embodiments, four groups of side openings 521 are provided and evenly distributed in the circumferential direction of the side wall 520. As a result, portions of the side wall 520 at different orientations can be broken off and removed according to actual use requirements, while the remaining portions of the side wall 520 can still ensure that the terminal protection cover 500 is stably mounted on and cover the output terminal 420.

In some other optional embodiments, the projection of the base portion 510 on the first plane is polygonal; and the side wall 520 includes three or more sub-side plates 522, each of which includes two side connecting edges opposite to each other and extending in the first direction (Z direction as shown in FIG. 1), wherein the three or more sub-side plates 522 are connected to each other by the side connecting edges to form a prism, and the side openings 521 are disposed adjacent to the side connecting edges. In these optional embodiments, the projection of the base portion 510 on a horizontal plane is in a shape of a polygon, and the side wall 520 includes three or more sub-side plates 522, each of which is connected to an edge of the peripheral region 511 corresponding to one side of the polygon.

In the case that the projection of the base portion 510 on the horizontal plane is polygonal, three or more groups of side openings 521 are provided and located adjacent to the side connecting edges of the three or more sub-side plates 522, and three or more base openings 512 are provided and respectively located between adjacent two groups of side openings 521. In these optional embodiments, the side openings 521 are disposed adjacent to each side connecting edge of each sub-side plate 522, and the base openings 512 are disposed between any adjacent two groups of side openings 521, such that any of the sub-side plates 522 can be broken off and removed according to actual use requirements.

In some optional embodiments, the snap component 530 includes a second snap member 532, wherein two or more second snap members 532 are provided and spaced apart from each other in the circumferential surface of the side wall. The output terminal 420 is provided two or more matching snap members 421 on an outer surface. The two or more matching snap members 421 are respectively disposed corresponding to the two or more second snap members 532, so that the terminal protection cover 500 can be secured to the output terminal in a snap fit manner via the two or more second snap members 532 and the two or more matching snap members 421. In these optional embodiments, since two or more second snap members 532 are provided, even if one of the second snap members 532 is broken off and removed, the terminal protection cover 500 can still be stably secured to the output terminal 420 in the snap fit manner by the remaining second snap members 532.

The specific configurations of the second snap member 532 and the matching snap member 421 are not particularly limited herein, as long as the second snap member 532 and the matching snap member 421 can be secured to each other in the snap fit manner. For example, the second snap member 532 is formed as a hole, and the matching snap member 421 is formed as a hook matching with the hole; or, the second snap member 532 is formed as a hook and the matching snap member 421 is formed as a hole matching with the hook.

It can be understood that the number of sides of the polygon corresponding to the projection of the base portion 510 on the horizontal plane, is not particularly limited herein. Preferably, the projection of the base portion 510 on the horizontal plane is rectangular, and the side wall 520 includes four sub-side plates 522. At least one side opening 521 is disposed adjacent to each of the two side connecting edges of each sub-side plate 522, and at least one base opening 512 is disposed between any adjacent two groups of side openings 521, so as to facilitate the broken off and removal of any sub-side plate 522 by means of the base opening 512 and the side opening 521. As a result, the user can remove any one of the sub-side plates 522 according to actual use requirements.

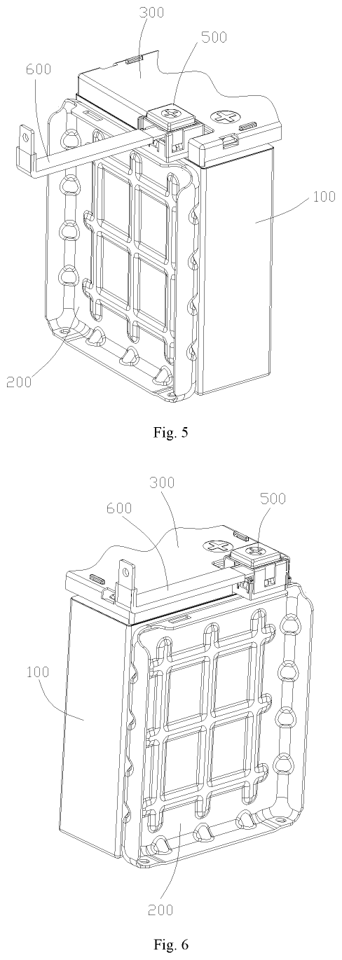

As shown in FIG. 5 to FIG. 7, when the battery modules are connected to each other by the connecting member 600, any of the sub-side plates 522 can be removed according to the use requirements, so that the connecting member 600 can be connected to the battery module in any of four orientations where the four sub-side plates are located.

The present disclosure can be implemented in any other specific manners without departing from the substantial features. The present embodiments are to be considered in all respects as illustrative and not limiting, and the scope of the present disclosure is defined by the appended claims while not the above description. Moreover, all modifications falling within the scope of the claims and the equivalents thereof are included within the scope of the present disclosure.

What is claimed is:

1. A terminal protection cover for a battery module, comprising:
a base portion, comprising a peripheral region and provided with base openings at the peripheral region; and
a side wall, connected to the peripheral region and extending in a first direction, wherein the side wall is provided with two or more groups of side openings spaced apart from each other and extending in the first direction, and at least one base opening is located between adjacent two groups of side openings such that a portion of the side wall can be removed by means of the at least one base opening and the adjacent two groups of side openings.

2. The terminal protection cover according to claim 1, wherein,
the base opening is formed as a blind slot recessed into the base portion in a thickness direction of the base portion.

3. The terminal protection cover according to claim 1, wherein,
the base opening is formed as a through slot extending through the entire base portion in a thickness direction of the base portion.

4. The terminal protection cover according to claim 1, wherein,
between adjacent two groups of side openings, there is disposed one base opening.

5. The terminal protection cover according to claim 1, wherein,
between adjacent two groups of side openings, there are disposed two or more base openings spaced apart from each other.

6. The terminal protection cover according to claim 1, wherein,
each group of side openings comprises one or more side wall slots recessed into the side wall in a thickness direction of the side wall, and in the case that each group of the side openings comprises two or more side wall slots, the two or more side wall slots are spaced apart in the first direction.

7. The terminal protection cover according to claim 6, wherein the side wall slot is formed as a blind slot.

8. The terminal protection cover according to claim 6, wherein the side wall slot is formed as a through slot extending through the entire side wall in the thickness direction of the side wall.

9. The terminal protection cover according to claim 1, wherein the side wall is formed into a circular cylinder or an elliptical cylinder.

10. The terminal protection cover according to claim 9, wherein,
the terminal protection cover comprises two or more base openings, and the two or more base openings are respectively located between adjacent two groups of side openings.

11. The terminal protection cover according to claim 1, wherein,
the side wall comprises three or more sub-side plates, each of which comprises two side connecting edges opposite to each other and extending in the first direction, wherein the three or more sub-side plates are connected to each other through the side connecting edges to form a prism, and the side openings are disposed adjacent to the side connecting edges.

12. The terminal protection cover according to claim 11, wherein,
the terminal protection cover comprises three or more groups of side openings, and the three or more groups of side openings are respectively disposed adjacent to the side connecting edges of the three or more sub-side plates; and
the terminal protection cover comprises three or more base openings, and the three or more base openings are respectively located between adjacent two groups of side openings.

13. A battery module, comprising:
a plurality of unit cells stacked in a second direction;
an end plate, disposed on one side of the plurality of unit cells in the second direction and provided with a limit through slot at an end in the first direction;
an upper cover, disposed on one side of the plurality of unit cells in the first direction, wherein the upper cover is provided with a groove disposed corresponding to the limit through slot;
an output component, comprising a limit terminal and an output terminal continuously connected to each other, wherein the limit terminal is located in the limit through slot and the output terminal is located in the groove; and
a terminal protection cover according to claim 1, covering the output terminal and located in the groove.

14. The battery module according to claim 13, wherein,
the side wall of the terminal protection cover is provided with a snap component such that the terminal protection cover can be secured to at least one of the output terminal and the upper cover by the snap component in a snap fit manner.

15. The battery module according to claim 14, wherein,
the groove comprises a first inner wall, a second inner wall, a third inner wall and a bottom wall, wherein the first inner wall and the second inner wall are disposed opposite to each other and are connected by the bottom wall, and the bottom wall is provided with a mating snap member; and
the snap component comprises a first snap member disposed toward the third inner wall, and the first snap member is fitted with the mating snap member such that the terminal protection cover can be secured to the upper cover via the first snap member and the mating snap member in the snap fit manner.

16. The battery module according to claim 14, wherein,
the snap component comprises two or more second snap members spaced apart in a circumferential surface of the side wall; and
the output component is provided with two or more matching snap members on an outer surface, and the two or more matching snap members are respectively disposed corresponding to the two or more second snap members such that the terminal protection cover is secured to the output terminal via the two or more second snap members and the two or more matching snap members in the snap fit manner.

17. The battery module according to claim 13, wherein,
the base opening is formed as a blind slot recessed into the base portion in a thickness direction of the base portion.

18. The battery module according to claim 13, wherein,
the base opening is formed as a through slot extending through the entire base portion in a thickness direction of the base portion.

19. The battery module according to claim 13, wherein,
between adjacent two groups of side openings, there is disposed one base opening.

20. The battery module according to claim 13, wherein,
between adjacent two groups of side openings, there are disposed two or more base openings spaced apart from each other.
